(19) United States
(12) Patent Application Publication
(10) Pub. No.: US 2004/0199384 A1
(43) Pub. Date: Oct. 7, 2004

(54) Speech model training technique for speech recognition

(76) Inventor: Wei-Tyng Hong, Hsinchu (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/686,607

(22) Filed: Oct. 17, 2003

(30) Foreign Application Priority Data
Apr. 4, 2003 (TW) 92107779

(51) Int. Cl. G10L 15/00

(52) U.S. Cl. 704/233

(57) ABSTRACT

The invention provides a speech model training technique for speech recognition. The training technique is first separating inputted speech and modeling it into a compact speech model with clean voice and an environmental interference model. Then, the environmental noises in the inputted speech will be filtered out according to the environmental interference model, and an environment-effect suppressed speech signal will be obtained. Next, the speech signal and the compact speech model will be estimated by the discriminative training algorithm to obtain a compact speech training model with high discriminative capability, which can be provided to the speech recognition device for its subsequent speech recognition processing. Therefore, the speech training model applying the algorithm of the invention can possess not only the robust capability and the discriminative capability, but also the high recognition rate. For this reason, the speech training model is suitable for compensation recognition in a noisy environment as well as capable of achieving precise control in environmental effects.

### BACKGROUND OF THE INVENTION

1. Field of the Invention

The invention relates to a training technique of speech recognition and, more particularly, to a speech model training technique with high recognition rate to be applied in a noisy environment.

2. Description of the Related Art

In recent years, the techniques for making electronic products have been incorporated with the techniques for making information and communication products. Through networks, all these techniques can be linked together. Benefiting from the advancement of these techniques, an automatic living environment has been created for more conveniences in living and working. As a result, a user is able to use a speech recognizer in various environments through different communication products. However, since noises generated in a noisy environment may vary, the recognition rate of a speech recognition device will eventually be deteriorated because of this variation.

There are two stages for speech recognition: the first is a training stage, and the second is a recognition stage. During the training stage, different voices will be collected first, and then by applying statistics, a speech model can be generated. After that, the speech model is applied to a learning procedure so that the speech recognition device can have a capability to learn. Then, the speech recognition capability of the device can be enhanced through iterative training as well as recognition technique by matching. Therefore, it is comprehensible that the training technique employed by a training model can significantly affect the recognition ability of the speech recognition device.

Conventional speech training techniques include two categories: one is the Discriminative Training (hereinafter referred to as DT), and the other is the Robust Training (Robust Environmental-effects Suppression Training, hereinafter referred to as REST). The DT technique is to employ a statistical method for collecting homogeneous phonetic signals that are easy to be confused. Then, when in training, the homogeneous speech training data will be taken into consideration for generating a model with high discriminative capabilities. For one thing, the DT technique can function efficiently in learning clean speech when employed in a quiet environment, whereas it may function less efficiently in a noisy environment. In addition to this drawback, the speech model generated by the DT technique in a noisy environment will tend to be over-fitting and lacking of generalization capability. It means that the DT model has been adapted to a model that is only suitable for a certain noisy environment, and when there is a change in that environment, the recognition effect can be decreased tremendously. Unlike the DT technique, the REST technique can statistically estimate the homogeneous phonetic information and suppress the environmental effects to enhance the robust capability of speech recognition. However, despite how robust the REST technique can be, its speech discriminative capability is less powerful than that of the DT technique.

Therefore, focusing on the aforementioned problems, the invention provides a speech model training technique for speech recognition that possesses both discriminative capability and robust capability in a noisy environment.

### SUMMARY OF THE INVENTION

The main and first object of the invention is to provide a speech model training technique for speech recognition, which first employs the REST technique to separate the environmental effects residing in the inputted speech, and then the remaining clean speech will be trained by the DT technique, so that the obtained speech training model can possess not only robust capability but also discriminative capability through both techniques; by doing so, the conventional problem, which is unable to concurrently own both capabilities, can then be resolved, and the recognition rate can be enhanced as well.

The second object of the invention is to provide a speech model training technique for speech recognition, which is suitable for compensation-based recognition in a noisy environment so as to enhance the efficiency of speech recognition rate in a noisy environment.

The third object of the invention is to treat each voice effect in the inputted speech as an individual voice effect and then separate it individually so that each distortion effect can be separated to achieve a precise control in environmental effects.

According to the invention, a speech model training technique for speech recognition includes the following steps: first, the inputted speech will be separated into one compact speech model of clean voice and one environmental interference model; next, according to the environmental interference model, the environmental effects in the inputted speech will be filtered out to obtain a phonetic signal; finally, the phonetic signal and the compact speech model will employ the DT algorithm and obtain a compact speech training model with high discriminative capability so as to provide the speech recognition device for the subsequent processing of speech recognition.

The objects and technical contents of the invention will be better understood through the description of the following embodiments with reference to the drawings.

### BRIEF DESCRIPTION OF THE DRAWINGS

FIG. 1(a) and FIG. 1(b) are schematic diagrams showing the structure of speech model training technique in the invention.

FIG. 2 is a schematic diagram showing a comparison of recognition results between the training technique of the prior art and the training technique of the invention.

FIG. 3 is a schematic diagram showing another comparison of recognition results between the training technique of the prior art and the training technique of the invention.

### DETAILED DESCRIPTION OF THE PREFERRED EMBODIMENTS

The speech model training technique of the invention first employs the REST technique to separate the inputted speech and make it into a compact speech model and an environmental interference model so that the compact speech model can be used as a seed model for model compensation. In addition, through the DT algorithm, a speech training model with high discriminative capability can be obtained so as to provide the speech recognition device for the subsequent processing of speech recognition.

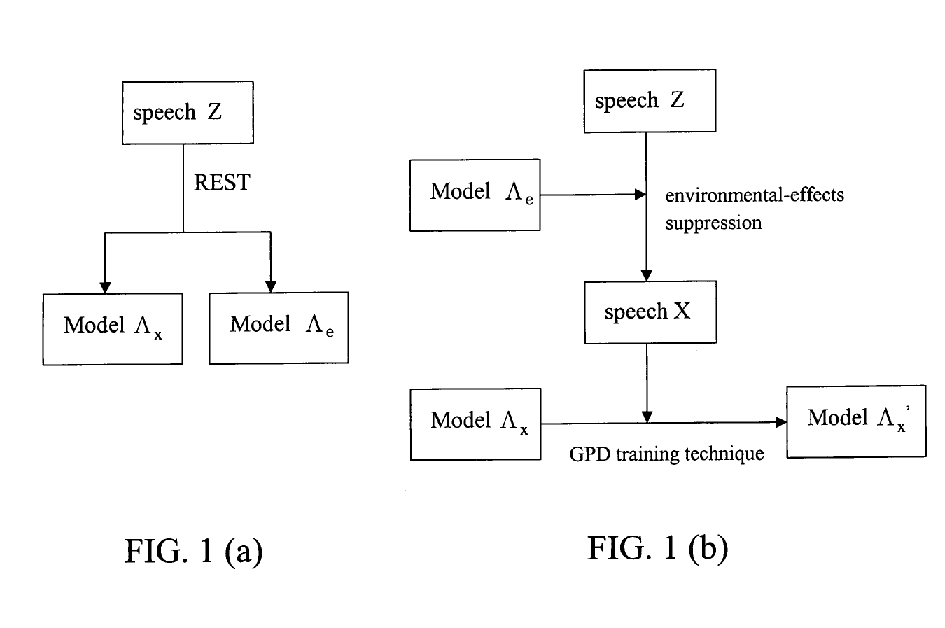

FIG. 1(a) and FIG. 1(b) are schematic diagrams showing the structure of speech model training technique in the invention. As shown in FIG. 1(a), the compact speech model Λₓ and an environmental interference model Λₑ will firstly be modeled and separated by employing the REST algorithm (1) on the inputted speech Z. Signals of the environmental interference model Λₑ include channel signals and noises. The examples of well-known channel signals are microphone effect and speaker bias. Next, as shown in FIG. 1(b), the environmental interference model Λₑ will be used for suppressing the environmental interference of the inputted speech Z so as to obtain a speech signal X. The process for filtering out the environmental interference usually is carried out by means of a filter. Finally, the generalized probabilistic descent (GPD) training scheme in the DT technique is employed to plug the speech signal X into the compact speech model Λₓ, that has been done with environmental-effects suppression. Then, after the calculation, a compact speech model Λₓ′ with high discriminative capability can be obtained.

After applying the algorithm of the invention and obtaining the compact speech model Λₓ′ with high discriminative capability, a method of parallel model combination (PMC) and a recognition method through signal bias compensation, usually referred to as the PMC-SBC (see the appendage 1), will be used during the recognition stage applied in the speech recognition device, so that the speech model Λₓ′ can be compensated to respond to the current operational environment, followed by a recognition procedure. The method of PMC-SBC will be illustrated as follows: first, by comparing the non-speech output of the Recurrent Neural Network (RNN) with a predetermined threshold, the non-speech frames can be detected, which can be used for calculating the on-line noise model. Next, the state-based Wiener filtering method will be employed, which utilizes the feature of stable random processing and the feature of spectrum to filter out the signals with noises, so that the r-th utterance of the inputted speech, referred to as Z^{(r)}, can be processed to obtain an enhanced speech signal. Then, the utterance Z^{(r)} of the enhanced speech signal will be converted into a Cepstrum Domain to estimate the channel bias by the SBR method. In turn, the SBR will estimate the bias by first encoding the feature vectors of the enhanced speech using a codebook and then calculating the average encoding residuals. To form a codebook, first, the mean vectors of mixture components in the compact speech Λₓ′ should be collected. Then, the channel bias is used to convert all the speech models Λₓ′ into bias-compensated speech models. Afterwards, these bias-compensated speech models will be further converted by means of the PMC method and the on-line noise model into noise- and bias-compensated speech models. Finally, these noise- and bias-compensated speech models can be used for subsequent recognition of the inputted utterance Z^{(r)}.

The speech model training technique of the invention can be applied to a device with a speech recognizer, such as a car speech recognizer, a PDA (Personal Digital Assistance) speech recognizer, and a telephone/cell-phone speech recognizer.

To sum up, the invention is to separate the noises in the inputted speech by using the REST technique, and then train the clean speech by using the DT technique. Through integrating the REST and DT techniques, the compact speech training model provided by the invention not only can own both robust capability and discriminative capability, but also can be adaptable to compensation recognition in a noisy environment. In addition, because the learning technique provided by the invention is able to individually separate each voice effect in the inputted speech, each distortion effect can be individually separated as well. Therefore, the learning technique can be applied to selective control of environmental-effect signal, for instance, the control of environmental effects to speech or the adaptability of a speech model.

So far, the algorithm of the invention has been described theoretically. In the following, a practical embodiment will be illustrated in detail to verify the algorithm of the invention. The algorithm of the invention is a combined technique of discriminative and robust training algorithms, referred to as the D-REST (Discriminative and Robust Environment-effects Suppression Training) hereinafter. The D-REST algorithm is that in a presumed noisy speech realization model, the homogeneous and clean speech X^{(r)} will pass through the noisy speech model and derive the Z^{(r)}, wherein the Z^{(r)} represents the speech feature vector sequence of the r-th utterance. Consider the set of discriminative functions {gᵢ, i=1,2 . . . ,M} with the environment-compensated speech HMMs (Hidden Markov Models) Λₓ^{(r)} of Z^{(r)} defined by

$$\begin{matrix}{g}_{i} ( {Z}^{( r )} ; {Λ}_{z}^{( r )} ) ≡ log [ Pr ( {Z}^{( r )} , {U}_{i}^{( r )} \vert {Λ}_{z}^{( r )} ) ] \\ = log [ Pr ( {Z}^{( r )} , {U}_{i}^{( r )} \vert {Λ}_{x} ⊗ {Λ}_{e} ) ]\end{matrix} \qquad ( 1 )$$

where Uᵢ^{(r)} is the maximum likelihood state sequence of Z^{(r)} to the i-th HMM of Λ_{z}^{(r)}; Λₓ denote the set of environment-effects suppressed HMMs (i.e., the compact speech model), and Λₓ is the set of environmental interference models. The symbol \mathring{×} denotes the operand of model compensation, which is also employed in the recognition process.

The goal of the D-REST algorithm is to estimate Λₓ and Λₑ with a set of discriminative functions {gᵢ, i=1,2 . . . ,M}, and to make Λₓ as a robust and discriminative seed model for model compensation-based noisy speech recognition.

The first stage of the D-REST algorithm is to concurrently estimate the compact speech models Λₓ and environmental interference models Λₑ. Assume that the environmental-effects comprise a channel b and an additive noise n on each utterance. Let Λₑ≡{Λₙ^{(r)},b^{(r)}}_{r=1 . . . ,R} denote the set of environmental interference models of the whole training data set, where b^{(r)} and Λₙ^{(r)} are, respectively, the signal bias and the noise model of the r-th training utterance. Based on the ML (maximum likelihood) criterion, the goal is to jointly estimate Λₓ and Λₑ with the given {Z^{(r)}}_{r=1 . . . ,R} by

$$( {Λ}_{x} , {Λ}_{e} ) = {arg max}_{( {\overline{Λ}}_{x} , {\overline{Λ}}_{e} )} Pr ( {\{ {Z}^{( r )} \}}_{r = 1 , … , R} \vert {\overline{Λ}}_{x} , {\overline{Λ}}_{e} ) \qquad ( 2 )$$

During the iterative training procedure, the REST technique will be sequentially employed to optimize the Equation (1), including the following three operations: (1) form the compensated HMMs Λ_{z}^{(r)} by using the current estimate {Λₓ,Λₑ} and use it to optimally segment the training utterance Z^{(r)}; (2) based on the segmentation result, estimate Λₙ^{(r)} and enhance the adverse speech Z^{(r)} to obtain Y^{(r)}, and then estimate b^{(r)} and further enhance the speech Y^{(r)} to obtain X^{(r)}; (3) update the current speech HMM models Λₓ using the enhanced speech {X^{(r)}}_{r=1 . . . ,R}.

Also, owing to the involvement of the environment-effect compensation operation in the training process, it can be expected that the better reference speech HMM models for the robust recognition method can be generated. Moreover, the separate modeling of Λₓ and Λₑ allows the training process to focus on the modeling of phonetic variation without the unwanted influence coming from the environmental effects.

The second stage of the D-REST algorithm is to perform a discriminative training with minimum classification error (MCE), and the algorithm is based on the observed speech Z with its environment-compensated speech HMM models Λ_{z}^{(r)}. The segmental GPD (generalized probabilistic decent)-based training procedure (see the appendage 2) is adopted here, with the following misclassification measure of Z^{(r)}:

dᵢ(Z^{(r)}|Λ_{z}^{(r)})=−gₖ(Z^{(r)};Λ_{z}^{(r)})+gₖ(Z^{(r)};Λ_{z}^{(r)}) (3)

where k=argmax_{j,j≠1}Pr(Z^{(r)},Uⱼ^{(r)}|Λ_{z}^{(r)}); from the equation (3) and by assuming that Σ_{z,j,q}^{(r)}=Σ_{x,j,q} and that the state-based Wiener filtering is the inverse operation of the PMC (see the appendage 3), the Pr(Z^{(r)},Uᵢ^{(r)}|Λ_{z}^{(r)} in the equation (1) can be rewritten as:

$$\begin{matrix}Pr ( {Z}^{( r )} , {U}_{i}^{( r )} \vert {Λ}_{z}^{( r )} ) = Pr ( {Z}^{( r )} , {U}_{i}^{( r )} \vert \{ {μ}_{x , j , q}^{( r )} + {b}^{( r )} - {h}_{j} , {{\sum }_{z , j , q}}^{( r )} \} ) \\ = Pr ( {X}^{( r )} , {U}_{i}^{( r )} \vert \{ {μ}_{x , j , q}^{( r )} , {\sum }_{x , j , q}^{( r )} \} ) \\ = Pr ( {X}^{( r )} , {U}_{i}^{( r )} \vert {Λ}_{x} )\end{matrix} \qquad ( 4 )$$

where the equation (3) can be expressed as:

dᵢ(Z^{(r)}|Λ_{z}^{(r)})=dᵢ(X^{(r)}|Λₓ) (5)

The equation (5) shows that performing the MCE-based training on Z and the environment-compensated HMM model Λ_{z}^{(r)} is equivalent to performing the MCE-based training on the environment-effects suppressed speech X with given compact model Λₓ.

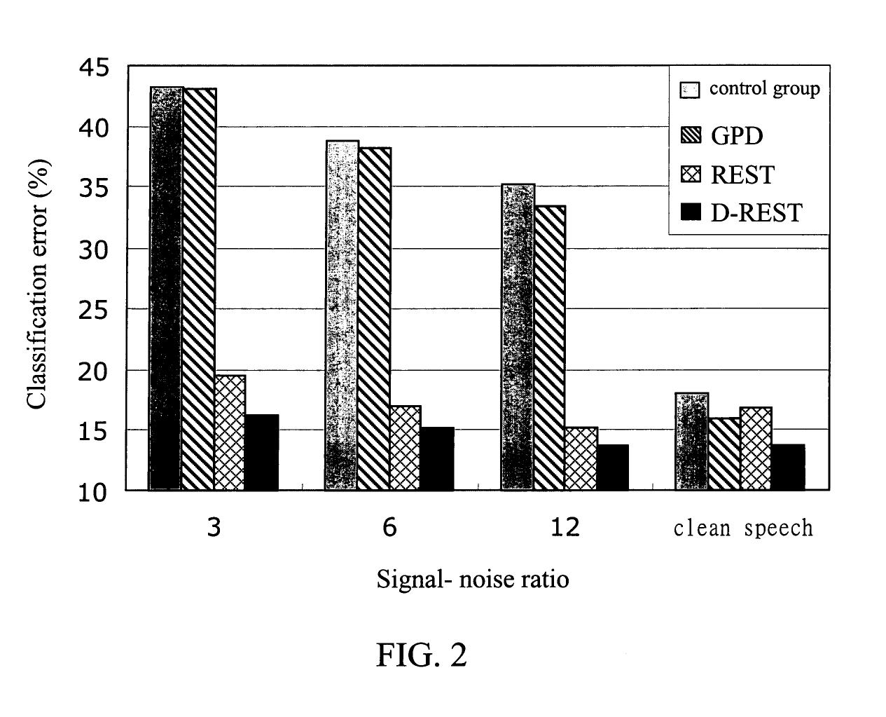

Therefore, from the implementation of the foregoing speech model training technique, a compact speech training model with high discriminative capability can be obtained. The following description will employ two embodiments to verify the functions and efficiency of the invention. Referring to FIG. 2, the first embodiment is to apply the D-REST technique of the invention, the generalized probabilistic descent training technique of the prior art, and the REST training technique in an in-car noisy environment with GSM (Global System for Mobile Communication) transmission channels. In the application, different speech classification errors in the environments with different noise ratios are compared, wherein the control group is using the conventional HMM recognition technique without any noise model compensation. After the comparison, it is obvious from the testing results that regardless of being in a clean-voice or a high-noise environment with a signal-noise ratio at 3, the minimum classification error can still be found when the in-car speech recognition device is using the D-REST speech model training technique of the invention. Therefore, the optimal recognition effect can well be achieved.

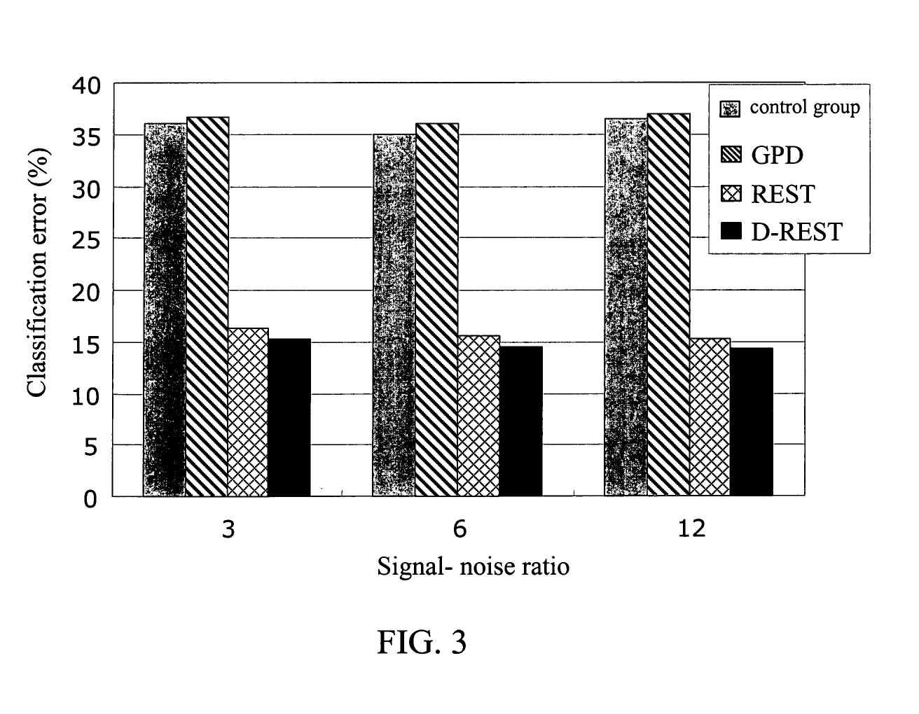

Also, another embodiment is shown in FIG. 3, in which the testing conditions and targets are the same as those of in the first embodiment. The only difference between the two embodiments is that the car noise type of the training corpus is different from that of the testing corpus. However, it can be understood from the tested result that when the D-REST speech model training technique of the invention is applied, the minimum classification error can be obtained regardless of the difference in signal-noise ratios. On the other hand, if the GPD training technique is applied, the result is worsen than that in the control group. The reason is that the generated speech model is over-fitting and lacking of generalization. Therefore, even though the environment for testing only has a slight change, the recognition effect will respond with a serious decrease.

The embodiments above are only intended to illustrate the invention; they do not, however, to limit the invention to the specific embodiments. Accordingly, various modifications and changes may be made without departing from the spirit and scope of the invention as described in the following claims.

What is claimed is:

1. A speech model training technique for speech recognition, including the following steps:
separating the inputted speech into a compact speech model with clean voice and an environmental interference model;
filtering out the environmental effects of the inputted speech according to the environmental interference model and obtaining a speech signal; and
pluging the speech signal into the compact speech model and deriving a speech training model by using the discriminative training algorithm so as to provide the speech recognition device with the speech training model for subsequent speech recognition processing.

2. The speech model training technique for speech recognition as claimed in claim 1, wherein the signals of the environmental interference model include a channel signal and noise.

3. The speech model training technique for speech recognition as claimed in claim 2, wherein the channel signal includes microphone channel effect.

4. The speech model training technique for speech recognition as claimed in claim 2, wherein the channel signal includes the speaker bias.

5. The speech model training technique for speech recognition as claimed in claim 1, wherein the discriminative training technique is a generalized probabilistic descent (GPD) training technique.

6. The speech model training technique for speech recognition as claimed in claim 1, wherein the step of separating the inputted speech is to compare the non-speech output of the Recurrent Neural Network (RNN) with a predetermined threshold to detect the non-speech frames, and then apply the non-speech frames for calculating the on-line noise model.

7. The speech model training technique for speech recognition as claimed in claim 1, wherein the step of filtering out the environmental effects is performing by a filter.

8. The speech model training technique for speech recognition as claimed in claim 1, wherein the step of filtering out the environmental effects further includes the following steps:
employing the state-based Wiener filtering method to process the inputted speech so that the compact speech model can become an enhanced speech;
converting the enhanced speech into a Cepstrum Domain to estimate the channel bias by the signal bias compensation (SBR) method and then converting the compact speech model into a bias-compensated speech model; and
employing the parallel model combination (PMC) method and the on-line noise model to convert the bias-compensated speech model into noise- and bias-compensated speech models.

9. The speech model training technique for speech recognition as claimed in claim 8, wherein the signal bias-compensated method is to employ a codebook to encode the feature vectors of the enhanced state-based speech and then calculate the average encoding residuals, wherein the codebook is formed by collecting the mean vectors of mixture components in the compact speech models.
